(19) United States
(12) Patent Application Publication
(10) Pub. No.: US 2010/0306010 A1
(43) Pub. Date: Dec. 2, 2010

(54) INTERACTIVE MAP/DIAGRAM OF ERP CODE AND MODEL ELEMENTS

(75) Inventors: Jacob Winther, Copenhagen (DK); Torben Wind, Copenhagen (DK); Stine Balthazar-Christensen, Valby (DK)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 12/476,204

(22) Filed: Jun. 1, 2009

(51) Int. Cl. G06Q 10/00; G06F 3/048

(52) U.S. Cl. 705/8; 715/764

(57) ABSTRACT

A diagramming system for dynamically generating and rendering a diagram depicting graphical representations of modules and elements of an ERP application, and their dependencies, is provided. In some embodiments, the diagramming system provides a dynamic, interactive graphical representation of user-selected elements and/or modules and their dependencies. In some embodiments, the diagramming system allows a user to view additional information about a specific element, such as the dependencies associated with that element that are not displayed in the diagram and also to select these elements for inclusion in the diagram. In this manner, the user can customize the diagram to show additional dependency information for a specific element or set of elements in which the user is interested. In some embodiments, the diagramming system may display an indication of dependencies between the selected element and the modules.

### BACKGROUND

Enterprise Resource Planning (“ERP”) software is a type of software used by many companies to plan and manage various business functions, such as budgeting, accounting, human resources, inventory management, customer relationship management, and so forth. Typically a customer or a third-party consultant (ERP application developer) will customize an ERP application to satisfy that customer's specific business requirements. To customize an ERP application, the customer or consultant may develop custom code that uses functionality exposed by the ERP application. Such customizations may improve the usability of the ERP applications or provide additional functionality.

As discussed above, ERP software typically includes support for many areas of business. ERP software applications provide support for each of these areas via hundreds or thousands of elements, each providing a particular function (e.g., logic and/or interfaces) for interacting with ERP data. Some ERP applications may implement these elements imperatively (i.e., using an explicit sequence of commands) while some ERP applications may implement these elements declaratively (i.e., declaring actions to be performed without providing an explicit sequence of commands for performing those actions). In some ERP applications, elements implemented imperatively are called code elements while elements implemented declaratively are. called model elements or data elements. Still other ERP applications may provide elements that individually comprise a combination of imperative and declarative parts. Elements of a typical ERP application include, among other things, tables for storing information, pages, forms, and reports for displaying information, and codeunits for performing logic of the ERP application. Furthermore, the elements may be grouped according to any number of overlapping modules (i.e., some elements may be associated with multiple modules). For example, an inventory management module may include various tables that store information about the items the company has in inventory along with a number of forms, pages, and reports for displaying the inventory information. As another example, an invoicing module may include tables storing customer information along with forms for generating an invoice to provide to a customer. The elements may depend on one another. For example, an invoicing form may extract data from a customer table, a sales table, and an inventory table while an inventory form extracts data from an inventory table and a supplier table. As another example, a codeunit in one module may rely on a function implemented by another codeunit in the processing of information. From the above, it follows that a number of element-element, module-element and module-module dependencies may exist within the ERP application.

When an ERP application developer is modifying an element or module of an ERP application, the developer may want to know how the modifications can impact the entire ERP application. Because the effect of modifying a single element can extend to other elements and unrelated modules due to the interdependent relationships discussed above, the ERP application developer may want to know which elements and/or modules depend on an element prior to modifying the element. For example, before altering an inventory table, the ERP application developer may want to know which elements depend on the table for rendering information so that the ERP application developer can identify and modify those elements, if necessary, to adjust for the change to the table. ERP application providers often provide a static diagram that represents the dependencies of the elements and modules of the ERP application. For example, an ERP application may be packaged with a foldout “map,” showing element-element, element-module, and module-module dependencies, and/or an electronic version of the map. Due to the number of elements and modules of a typical ERP application, and the number of dependencies between these elements and modules (which can number in the thousands), these static maps are often cumbersome, overly complicated, and difficult to use effectively. Furthermore, the static mapping does not reflect any changes to the ERP application made since the mapping was generated. For example, if new elements are added to an ERP application or an element is modified to create a new dependency in the ERP application, these changes will not be reflected on the static map. Accordingly, a static map can quickly become out of date for a changing ERP application. Moreover, the static map does not allow an ERP application developer to select for display only those elements or modules in which the developer is interested.

### SUMMARY

A diagramming system for dynamically generating and rendering a diagram depicting graphical representations of modules and elements of an ERP application, and their dependencies, is provided. In some embodiments, the diagramming system provides a dynamic, interactive graphical representation of user-selected elements and/or modules. The diagramming system dynamically identifies the dependencies between the elements of the selected modules (i.e., the dependencies that are “internal” to the selected modules) and adds a graphical representation of these dependencies to the dependency diagram. Because of this dynamic identification of dependencies, the graphical representation illustrates all of the current dependencies including any resulting from recent changes or customizations to the ERP application. The user may then interact with the diagram by, for example, zooming out to see more of the diagram, zooming in to see a specific area of the diagram up close, changing the position of the any of the graphical representations, dynamically adding additional elements and/or modules to the diagram, etc. In some embodiments, the diagramming system allows a user to view additional information about a specific element, such as dependencies associated with that element that are not displayed in the diagram (i.e., the dependencies that are “external” to the selected modules). Additionally, the diagramming system may allow the user to add any number of these “external” elements to the diagram along with an indication of any dependencies associated with the “external” elements and the elements associated with the selected modules. In this manner, the user can customize the diagram to show additional dependency information for a specific element or set of elements in which the user is interested. In some embodiments, the diagramming system may display an indication of dependencies between the selected element and the modules. In this manner, the user can identify and display the modules that may be of interest to the user based on their dependency relationship with a particular element.

This Summary is provided to introduce a selection of concepts in a simplified form that are further described in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram illustrating components of the diagramming system in some embodiments.

FIG. 2 is a block diagram illustrating an element store, a module store, and a dependency store of the diagramming system in some embodiments.

FIG. 3 is a block diagram illustrating the processing of a draw diagram component of the diagramming system in some embodiments.

FIG. 4 is a block diagram illustrating the processing of an identify dependencies module of the diagramming system in some embodiments.

FIG. 5 is a block diagram illustrating the processing of a draw elements component of the diagramming system in some embodiments.

FIGS. 6A-6D are display pages illustrating sample diagrams generated by the diagramming system in some embodiments.

FIG. 7 is a block diagram illustrating the processing of an expand element component of the diagramming system in some embodiments.

FIGS. 8A-8C are display pages illustrating sample diagrams generated by the diagramming system in some embodiments.

### DETAILED DESCRIPTION

A diagramming system for dynamically generating and rendering a diagram depicting graphical representations of modules and elements of an ERP application, and their dependencies, is provided. In some embodiments, the diagramming system provides a dynamic, interactive graphical representation of user-selected elements and/or modules. For example, a user may select a number of modules of the ERP application. As another example, the user may select a number of elements and the diagramming system may display a list of modules associated with the selected elements for the user's selection. As another example, the diagramming system may automatically select the modules associated with the user-selected elements. Upon receiving the selection, the diagramming system identifies the elements of the selected modules and adds a graphical representation of each of the identified elements to a dependency diagram. Furthermore, the diagramming system dynamically identifies the dependencies between the elements of the selected modules (i.e., the dependencies that are “internal” to the selected modules) and adds a graphical representation of these dependencies to the graphical representation of the elements and their associated dependencies. Because of this dynamic identification of dependencies, the graphical representation illustrates all of the current dependencies including any resulting from recent changes or customizations to the ERP application. By way of example, if a form associated with one of the selected modules depends on a table in the same or another one of the selected modules, the diagramming system may draw an arrow from the graphical representation of the form to the graphical representation of the table. In this example, the form is said to have an “outgoing dependency” to the table while the table is said to have an “incoming dependency” from the form. The user may then interact with the diagram by, for example, zooming out to see more of the diagram, zooming in to see a specific area of the diagram up close, changing the position of the any of the graphical representations, dynamically adding additional elements and/or modules to the diagram, etc.

In some embodiments, the diagramming system allows a user to view additional information about a specific element. For example, once a diagram has been displayed, a user can select a graphical representation of an element from the diagram to view information about dependencies associated with that element that are not displayed in the diagram (i.e., the dependencies that are “external” to the selected modules). For example, the diagramming system may display a list of elements that are not associated with the selected modules, and that depend on the selected element or on which the selected element depends. Additionally, the diagramming system may allow the user to add any number of these “external” elements to the diagram along with an indication of any dependencies associated with the “external” elements and the elements associated with the selected modules. In this manner, the user can customize the diagram to show additional dependency information for a specific element or set of elements in which the user is interested.

In some embodiments, the diagramming system may display an indication of dependencies between the selected element and the modules. For example, when the user selects an indication of an element in the diagram the diagramming system may update a list of modules from which the user may select specific modules to be included in the diagram. When a user selects an indication of an element from the diagram, the diagramming system may display an outgoing arrow (e.g., an arrow that points in a predetermined direction or has a predefined color) next to each item in the list that corresponds to a module associated with at least one element that depends on the selected element. Similarly, the diagramming system may display an incoming arrow (e.g., an arrow that points in a predetermined direction or has a predefined color) next to each item in the list that corresponds to a module associated with at least one element on which the selected element depends. In this manner, the user can identify and display the modules that may be of interest to the user based on their dependency relationship with a particular element. Furthermore, the dependencies may be implemented declaratively (i.e., associated with a declarative part of an element) or imperatively (i.e., associated with an imperative part of an element). Dependencies may be categorized according to the manner in which they are implemented. In some ERP applications, dependencies implemented imperatively are called code dependencies while elements implemented declaratively are called model dependencies or data dependencies.

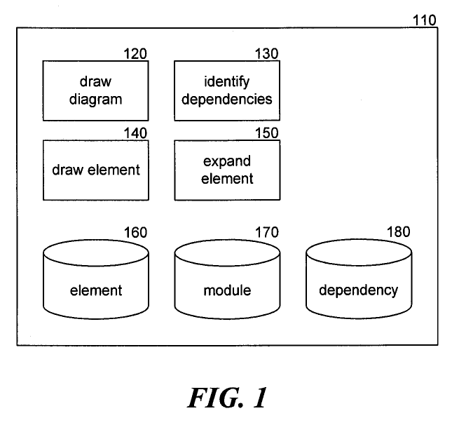

FIG. 1 is a block diagram illustrating components of the diagramming system in some embodiments. Diagramming system 110 includes draw diagram component 120, identify dependencies component 130, draw element component 140, expand element component 150, element store 160, module store 170, and dependency store 180. Draw diagram component 120 generates and renders a diagram based on a selection of modules and/or elements. Identify dependencies component 130 identifies dependencies associated with a set of elements or modules as internal (i.e., between elements or modules of the set) or external (i.e., between an element or module within the set and an element or module that is not a member of the set). Draw element component 140 renders a set of elements and related dependencies. Expand element component 150 allows a user to add elements to a diagram that depend on or depend from a selected element currently displayed in the diagram. Element store 160 stores information about elements, such as their type and their dependency relationships. Module store 170 stores associations between modules and elements (i.e., which elements are associated with which modules). Dependency store 180 stores information about dependencies, such as a dependency origin, a dependency target, and a dependency type (or category).

The computing devices on which the diagramming system is implemented may include a central processing unit, memory, input devices (e.g., keyboard and pointing devices), output devices (e.g., display devices), and storage devices (e.g., disk drives). The memory and storage devices are computer-readable media that may be encoded with computer-executable instructions that implement the diagramming system, which means a computer-readable medium that contains the instructions. In addition, the instructions, data structures, and message structures may be stored or transmitted via a data transmission medium, such as a signal on a communication link and may be encrypted. Various communication links may be used, such as the Internet, a local area network, a wide area network, a point-to-point dial-up connection, a cell phone network, and so on.

Embodiments of the diagramming system may be implemented in and used with various operating environments that include personal computers, server computers, handheld or laptop devices, multiprocessor systems, microprocessor-based systems, programmable consumer electronics, digital cameras, network PCs, minicomputers, mainframe computers, computing environments that include any of the above systems or devices, and so on.

The diagramming system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

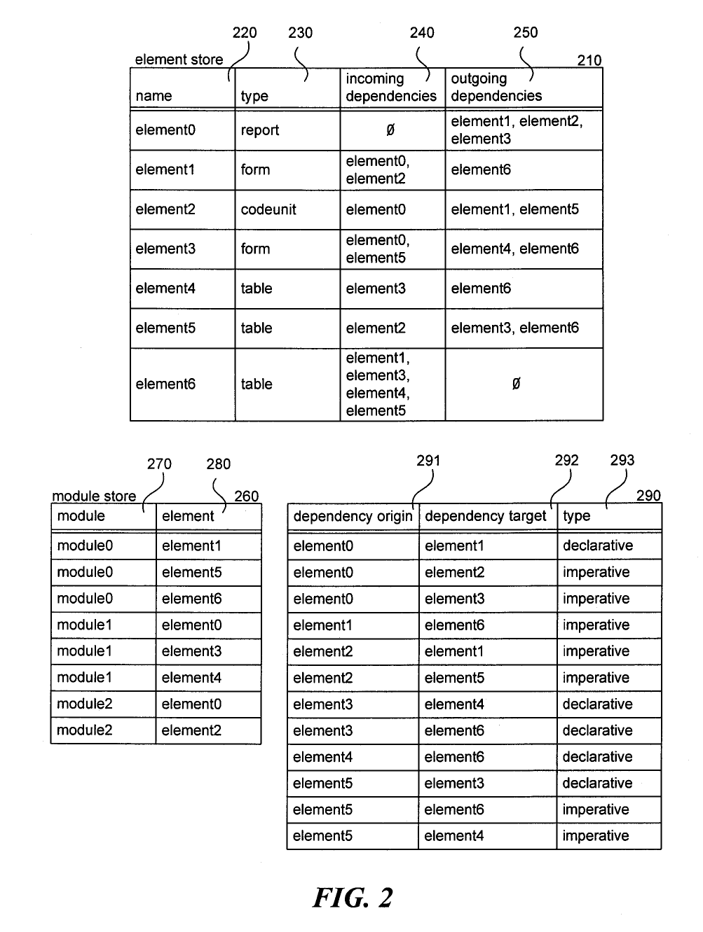

FIG. 2 is a block diagram illustrating an element store, a module store, and a dependency store of the diagramming system in some embodiments. In this example, element store 210, module store 260, and dependency store 290 are represented as tables. Element store 210 stores information about a plurality of elements. In this example, element store 210 consists of name column 220, type column 230, incoming dependencies column 240, and outgoing dependencies column 250. Name column 220 stores the name of an element associated with a particular row in the table (e.g., element0, element1, etc.). Type column 230 stores the type associated with the element of a particular row (e.g., report, form, codeunit, etc.). Incoming dependencies column 240 stores a list of incoming dependencies associated with the element of a particular row. In other words, each of the elements listed in incoming dependencies column 240 for a particular row depend on the element associated with that row. In this example, element0 and element2 depend on element1 while no elements depend on element0 (as indicated by the Ø symbol). Outgoing dependencies column 250 stores a list of outgoing dependencies associated with the element of a particular row. In other words, the element associated with a particular row depends on each of the elements listed in outgoing dependencies column 250 for the particular row. In this example, element0 depends on element1, element2, and element3 while element6 does not depend on any elements (as indicated by the Ø symbol). In some embodiments, declarative element parts and imperative element parts may be stored in separate element stores. In some embodiments, the element store may include a column indicating whether each dependency is implemented declaratively or imperatively.

In some embodiments, an indication of dependency relationships may be stored in a dependency store, such as dependency store 290. In this example, each row of the table representing the dependency between two elements and whether the dependency is implemented declaratively or imperatively (i.e., type). Dependency store 290 consists of dependency origin column 291, dependency target column 292, and type column 293. Dependency origin column 291 identifies the dependent element in the dependency relationship associated with a particular row while dependency target column 292 identifies the element on which the dependent element depends. Type column 293 indicates whether the dependency is implemented declaratively or imperatively. For example, the first row in dependency store 290 indicates that element0 depends on element1 and that the dependency is implemented declaratively.

Module store 260 stores an indication of associations between modules and elements. The diagramming system may use module store 260, for example, to determine which elements are associated with a particular module and, conversely, which modules are associated with a particular element. In this example, module store 260 is represented as a table consisting of module column 270 and element column 280. Module column 270 stores the name of a module and element column 280 stores the name of an element. In this example, module0 is associated with element1, element5, and element6 while element0 is associated with module1 and module2. One skilled in the art will recognize that while FIG. 2 provides an illustration that is easily comprehensible by a human reader, the actual information may be stored using different data structures and data organizations.

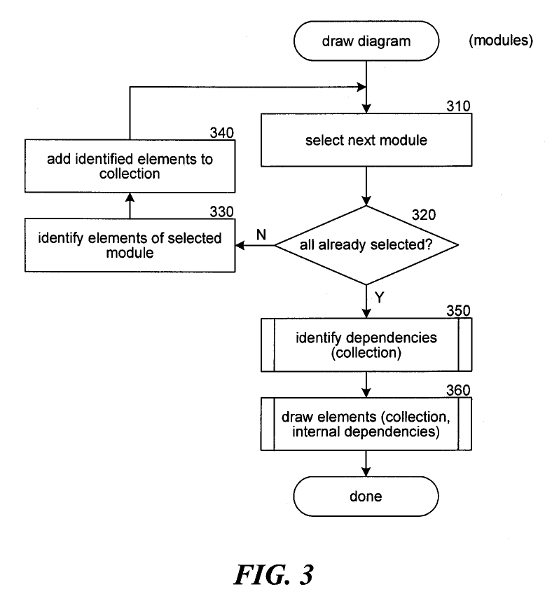

FIG. 3 is a block diagram illustrating the processing of a draw diagram component of the diagramming system in some embodiments. The component is invoked to draw a diagram given a set of modules passed to the component. In block 310, the component selects the next module. In decision block 320, if all of the components have already been selected then the component continues processing at block 350, else the component continues processing at block 330. In block 330, the component identifies the elements associated with the selected module. As an example, the component may retrieve the identification of elements associated with a module from a module store. In block 340, the component adds the identified elements to a collection of elements and then loops back to block 310 to select the next module. In block 350, the component invokes an identify dependencies component to identify the dependencies associated with the elements within the collection of elements. In block 360, the component invokes a draw elements component to draw the collection of elements and the internal dependencies of the collection (i.e., dependencies from one element of the collection to another element associated with one of the selected modules). Processing of the component then completes.

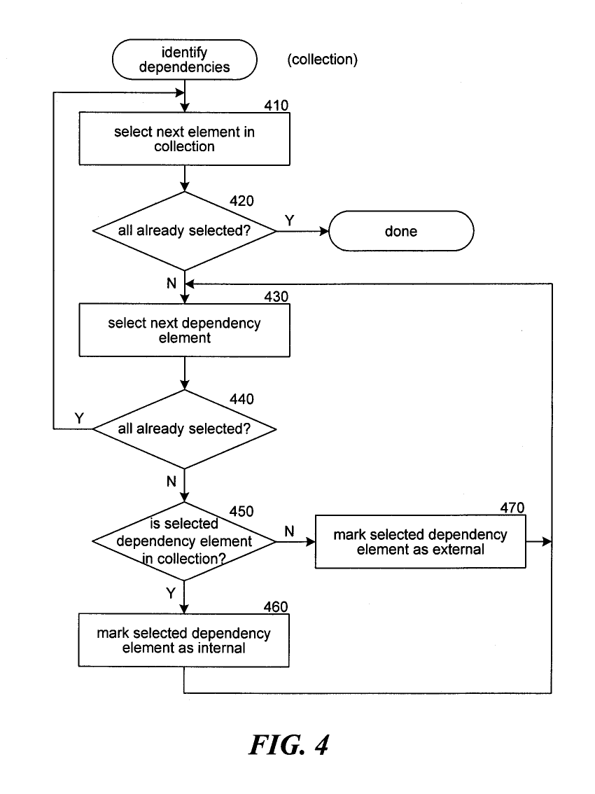

FIG. 4 is a block diagram illustrating the processing of an identify dependencies module of the diagramming system in some embodiments. The component is invoked to identify internal and external dependencies associated with a collection of elements passed to the component. In block 410, the component selects the next element in the collection. In decision block 420, if all of the elements have already been selected, then processing of the component completes, else the component continues processing at block 430. In block 430, the component selects the next dependency element associated with the selected element (i.e., an element that depends on the selected element or on which the selected element depends). The component may, for example, retrieve the identities of the dependency elements from an element store. In decision block 440, if all of the dependency elements have already been selected, then the component loops back to block 410 to select the next element in the collection, else processing continues at decision block 450. In decision block 450, if the selected dependency element is in the collection, then in block 460 the component marks the selected dependency element as internal, else in block 470 the component marks the selected dependency element as external. The component then loops back to block 430 to select the next dependency element associated with the selected element in the collection.

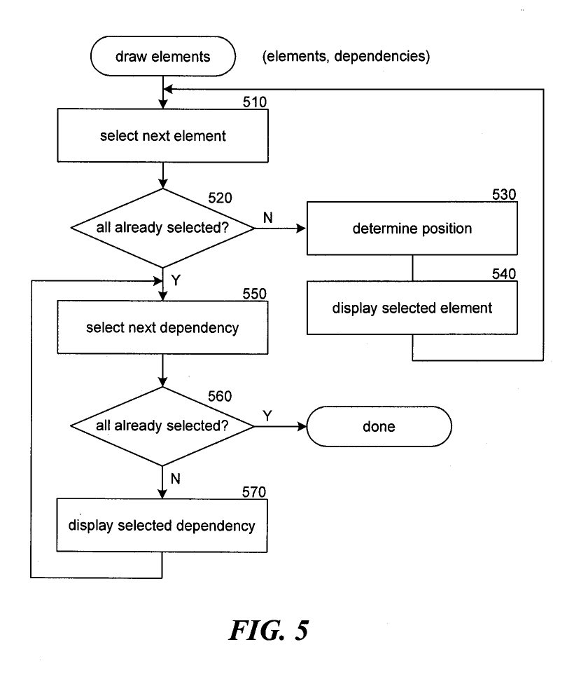

FIG. 5 is a block diagram illustrating the processing of a draw elements component of the diagramming system in some embodiments. The component is invoked to draw a set of elements and the associated dependencies that are passed to the component. In block 510, the component selects the next element from the set of elements passed to the component. In decision block 520, if all of the elements have already been selected, then the component continues processing at block 550, else the component continues processing at block 530. In block 530, the component determines a position to display an indication of the selected element. The component may determine where to display the selected element based on, for example, the number of elements passed to the component, the number of dependencies associated with the selected element, the position of previously displayed indications of elements, etc. In block 540, the component displays the selected element by, for example, drawing an indication of the selected element at the determined position. The component then loops back to block 510 to select the next element. In block 550, the component selects the next dependency from the set of dependencies passed to the component. In decision block 560, if all of the dependencies have already been selected, then processing of the component completes, else the component continues processing at block 570. In block 570, the component displays the selected dependency by, for example, drawing an arrow from the dependent element associated with the dependency to the associated element on which the dependent element depends. The component then loops back to block 550 to select the next dependency.

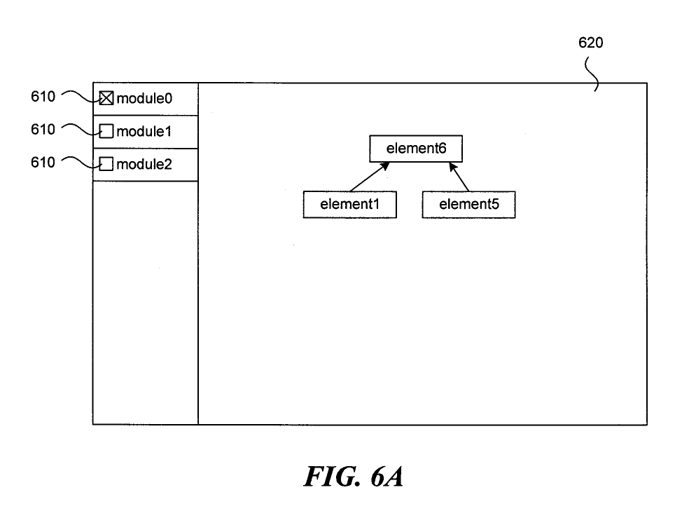

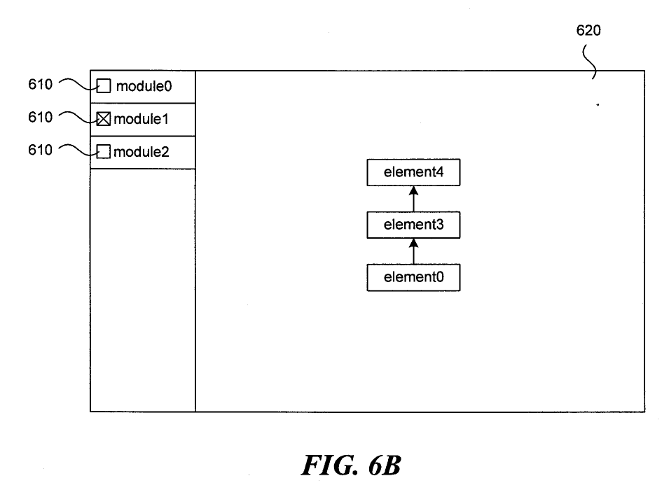

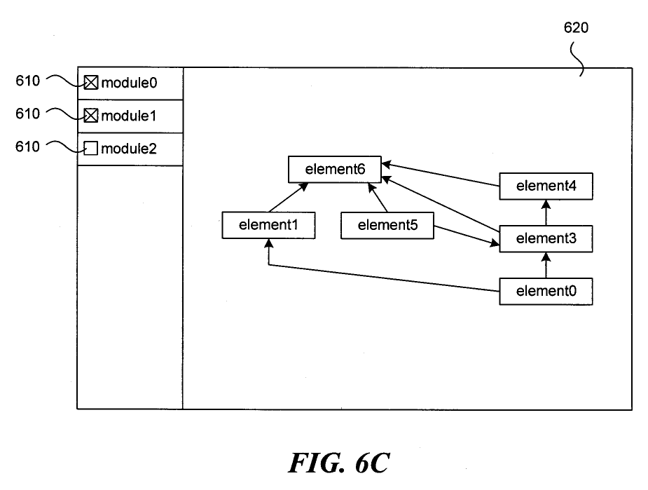

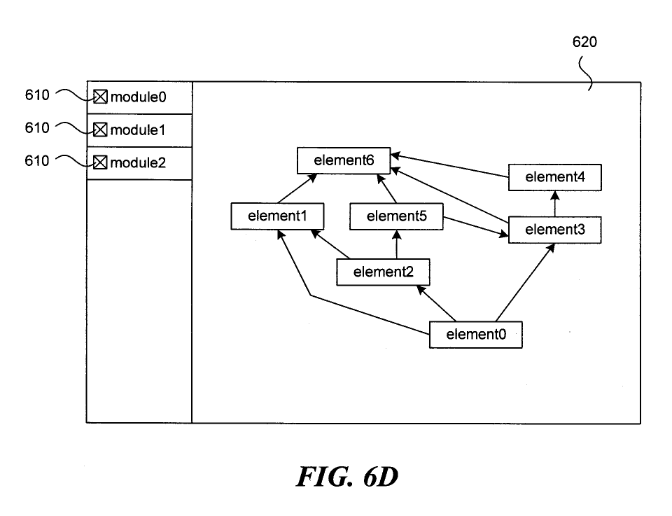

FIGS. 6A-6D are display pages illustrating sample diagrams generated by the diagramming system in some embodiments. In this example, each display page includes an indication of each of the available modules along with a checkbox for selecting the modules 610 and a diagram 620. In FIG. 6A, module0 has been selected as indicated by the “X” in the checkbox next to “module0.” Accordingly, an indication of each of the dependency elements associated with module0 in module store 260 (i.e., element1, element5, and element6) are displayed in diagram 620 along with an indication of the dependencies between those elements, as indicated in element store 210. In this example, both element1 and element5 have an outgoing dependency to element6. Accordingly, element6 has incoming dependencies from element1 and element5. In FIG. 6B, module1 has been selected and an indication of each of the elements associated with module1 are displayed in diagram 620 along with an indication of the dependencies between those elements, as indicated in element store 210. In FIG. 6C, module0 and module1 have both been selected and an indication of each of the elements associated with module0 and module1 are displayed in diagram 620 along with an indication of the dependencies between those elements, as indicated in element store 210. Diagram 620 in FIG. 6C includes graphical representations of more dependencies than the combination of the diagrams in FIGS. 6A and 6B. This is because FIG. 6C includes the dependencies existing between elements of module0 and module1 not represented when displaying indications of elements associated only with module0 or only with module1. Accordingly, FIG. 6C includes an indication of dependencies from element0 to element1, from element5 to element3, from element3 to element6, and from element4 to element6, all of which are not shown in either FIG. 6A or FIG. 6B. In FIG. 6D, module0, module1, and module2 have been selected and an indication of each of the elements associated with those modules are displayed in diagram 620 along with an indication of the dependencies between those elements, as indicated in element store 210.

The dynamic nature of the diagramming system is reflected in the following examples. Looking back at FIG. 6C, if an ERP application developer were to remove element4 from the ERP application, the diagramming system may automatically adjust the diagram to remove the graphical representations of element4 and any of its related dependencies. Furthermore, the graphical representations remaining in the diagram may be repositioned. As another example, if an ERP application developer modified element6 to depend on element3, the diagramming system may automatically update the diagram to include a graphical representation of the dependency (e.g., an arrow from element6 to element3). As another example, if an ERP application developer disassociated element1 from module0, the diagramming system may automatically remove the graphical representation of element1, along with the graphical representations of the dependencies associated with element1, from diagram 620 and update the display of the diagram.

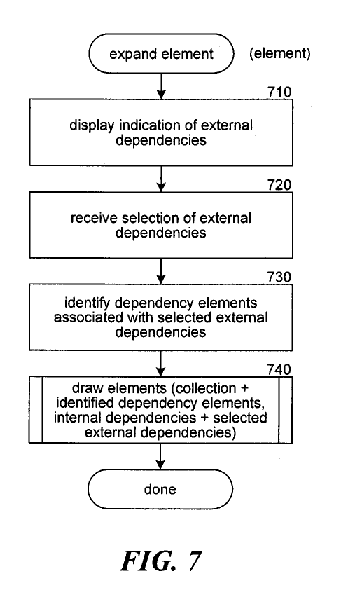

FIG. 7 is a block diagram illustrating the processing of an expand element component of the diagramming system in some embodiments. The component is invoked to allow a user to expand the number of dependencies shown in a diagram for a displayed element passed to component. The element passed to the component may, for example, correspond to an element selected by a user. In block 710, the component displays an indication of the external dependencies associated with the element (i.e., dependencies associated with the selected element that are not associated with another element associated with the currently selected modules). For example, the component may display a list of elements associated with the external dependencies adjacent to the diagram. In block 720, the component receives a selection of external dependencies. For example, a user may make a selection from the list of elements displayed adjacent to the diagram. As another example, the component may allow a user to select an option to display all of the outgoing external dependencies associated with the selected element, all of the incoming external dependencies associated with the selected element, or both. In block 730, the component identifies the dependency elements associated with the selected external dependencies. In block 740, the component invokes a draw elements component to draw the collection of elements (i.e., the elements associated with the currently selected modules) and the identified dependency elements along with the internal dependencies (i.e., the dependencies between elements of the selected modules) and the selected external dependencies. Processing of the component then completes.

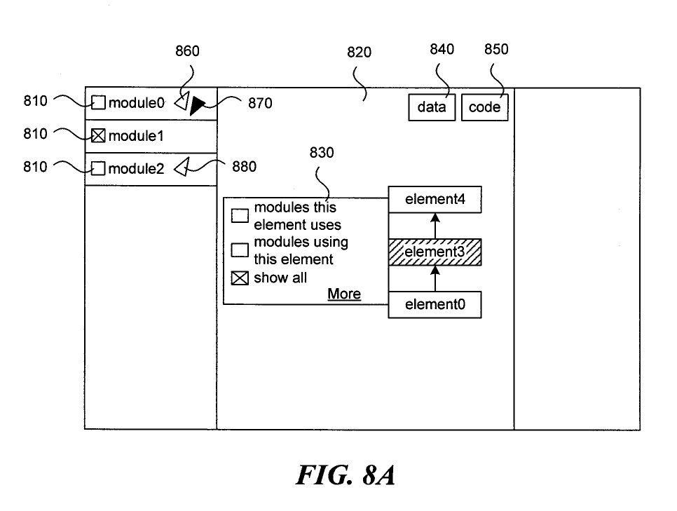

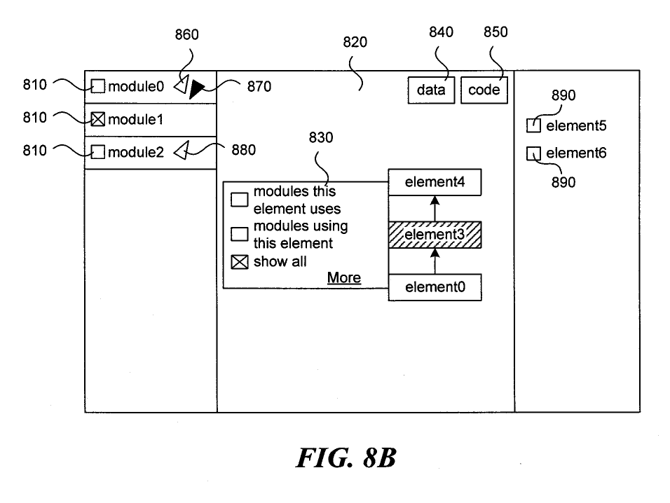

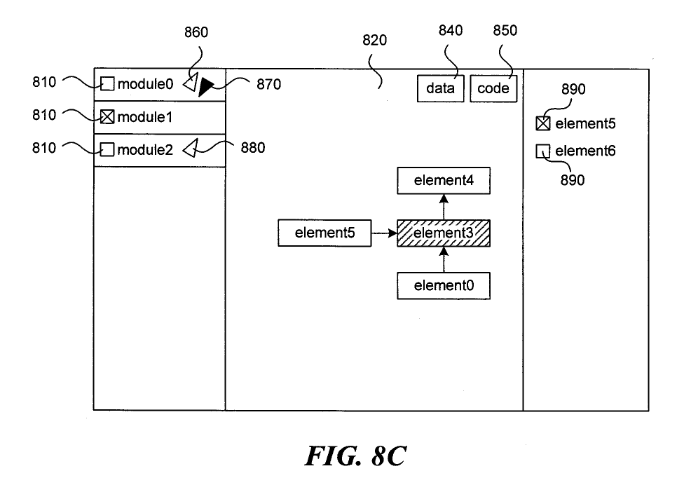

FIGS. 8A-8C are display pages illustrating sample diagrams generated by the diagramming system in some embodiments. In this example, display pages include an indication of each of the modules available for display along with checkboxes 810 for selecting a module for display, diagram 820, expansion options list 830, data mode selection button 840, code mode selection button 850, and dependency module indicators 860-880. Data mode selection button 840 and code mode selection button 850 allow a user to toggle between the display of dependencies implemented declaratively and dependencies implemented imperatively. For example, if a user selects data mode selection button 840, the diagramming system will display the elements associated with the selected modules, along with any associated declarative dependencies. As another example, if a user selects code mode selection button 850, the diagramming system will display the elements associated with the selected modules, along with any associated imperative dependencies. In some embodiments, a user can cause the diagramming system to show elements of the selected modules, along with both declarative and imperative associated dependencies, by selecting both mode selection buttons.

In FIG. 8A, module1 has been selected and the elements associated with module1 and its internal dependencies are represented in diagram 820 similar to FIG. 6B. In FIG. 8A, however, a user has selected element3 for expansion, as indicated by the shading in the representation of element5 in diagram 820. In response to the selection, the diagramming system has added an expansion options list 830 and dependency module indicators 860-880. Expansion options list 830 includes options for showing additional elements and the dependencies associated with the selected element. In this example, expansion options list 830 includes “modules this element uses” (i.e., all of the modules associated with elements on which the selected element depends), “modules using this element” (i.e., modules associated with elements that depend on the selected element), and “show all” (i.e., the modules associated with elements that depend on the selected element or on which the selected element depends). When a user selects one of these options, an indication of each of the associated module dependencies is added to the list of modules. For example, a user can use these options to toggle dependency module indicators 860-880. The dependency module indicators provide an indication of the modules that depend on the selected element or on which the selected element depends (i.e., modules associated with dependency elements of the selected element). In this example, dependency module indicator 860 indicates that module0 is associated with at least one element that has an outgoing dependency to element3 (the selected element), while dependency module indicator 870 indicates that module0 is associated with at least one element that has an incoming dependency from element3. Dependency module indicator 880 indicates that module2 is associated with at least one element that depends on element3. In this example, dependency module indicators are not shown for the currently selected modules (i.e., module1). In other embodiments, dependency module indicators may be shown for selected modules as well. The dependency module indicators assist a user in determining which modules to inspect, or include in the selected modules, when examining a particular element to dependency relationships. Expansion options list 830 also includes a “More” link that, when selected, provides a list of elements having a dependency relationship with the selected element and that are external to the selected modules. In some embodiments, the system may show a list of all elements having a dependency relationship with the selected element when a user selects the “More” link.

In FIG. 8B, the user has selected the “More” link in expansion options list 830, resulting in the display of a list dependency elements of element3 that are external to the selected modules (i.e., element5 and element6), each of which can be selected for inclusion in the diagram via a checkbox 890.

In FIG. 8C, the user has selected element5 for inclusion in the diagram resulting in the display of a graphical representation in diagram 820 along with a graphical representation of the dependencies between element5 and elements already displayed in the diagram.

Although the subject matter has been described in language specific to structural features and/or methodological acts, it is to be understood that the subject matter defined in the appended claims is not necessarily limited to the specific features or acts described above. For example, in some embodiments, the diagramming system may generate diagrams that show module-module dependencies without explicitly showing element-element dependencies. Rather, the specific features and acts described above are disclosed as example forms of implementing the claims. Accordingly, the invention is not limited except as by the appended claims.

I/we claim:

1. A method performed by a computer having a memory and a processor for dynamically displaying an interactive diagram of interdependent enterprise resource planning elements, each element implementing a feature of an enterprise resource planning application and being organized according to a set of enterprise resource planning modules, the method comprising:
receiving from a user a selection of enterprise resource planning modules, each module having a number of associated enterprise resource planning elements;
for each of the selected modules,
identifying, by the processor, the enterprise resource planning elements associated with the module, and
adding, by the processor, the identified enterprise resource planning elements to a collection of elements;
adding an indication of each element of the collection of elements to the interactive diagram;
identifying a first set of dependencies between elements of the collection of elements;
adding an indication of each of the first set of identified dependencies to the interactive diagram; and
displaying the interactive diagram.

2. The method of claim 1 wherein each dependency between elements is categorized as either declarative or imperative.

3. The method of claim 2, further comprising:
receiving a selection to display either declarative dependencies or imperative dependencies;
when identifying enterprise resource planning elements, only identifying enterprise resource planning elements associated with dependencies of the selected category; and
when identifying the first set of dependencies, only identifying dependencies of the selected category.

4. The method of claim 1, further comprising:
receiving a selection of an element, an indication of which is displayed in the interactive diagram;
identifying a second set of dependencies between the selected element and enterprise resource planning elements that are not part of the collection of elements;
receiving a selection of at least one of the identified dependencies from the second set of dependencies; and
displaying an indication of the at least one of the identified selected dependencies from the second set of dependencies.

5. The method of claim 1, further comprising:
receiving a selection of an element, an indication of which is displayed in the interactive diagram; and
displaying an indication of dependency modules of the selected element.

6. The method of claim 1 wherein the elements are selected from a group consisting of codeunits, forms, pages, reports, or tables.

7. The method of claim 1 wherein the collection of elements includes at least one table element and at least one non-table element so that both the at least one table element and at least one non-table element are displayed with the interactive diagram.

8. A computer-readable storage medium containing instructions for generating an interactive diagram representing dependent relationships between functional elements of a software package, by a method comprising:
receiving a selection of modules, each module identifying a number of associated functional elements, the selection of modules having been made by a user; and
for each of the functional elements associated with the selected modules, selecting the functional element,
displaying in an interactive diagram an indication of the selected functional element,
identifying internal incoming dependencies, each incoming dependency identifying a functional element associated with at least one of the selected modules and that depends on the selected functional element,
identifying internal outgoing dependencies, each outgoing dependency identifying a functional element associated with at least one of the selected modules and on which the selected functional element depends, and
displaying in the interactive diagram an indication of the identified internal incoming dependencies and the identified internal outgoing dependencies.

9. The computer-readable storage medium of claim 8 wherein each dependency between elements categorized as either declarative or imperative.

10. The computer-readable storage medium of claim 9, further comprising:
receiving a selection to display either declarative dependencies or imperative dependencies;
removing from the interactive diagram indications of dependencies corresponding to the selected dependency category.

11. The computer-readable storage medium of claim 8, further comprising:
receiving a selection of an indication of an element displayed in the interactive diagram;
identifying external dependencies associated with the selected element, each external dependency being associated with an element not associated with the selected modules;
displaying an indication of the identified external dependencies;
receiving a selection of at least one of the displayed external dependencies; and
displaying an indication of the selected at least one displayed external dependency.

12. The computer-readable storage medium of claim 11 wherein the selected at least one displayed external dependency is associated with an element that depends on the selected element.

13. The computer-readable storage medium of claim 11 wherein the selected at least one displayed external dependency is associated with an element on which the selected element depends.

14. The computer-readable storage medium of claim 8 wherein the interactive diagram includes at least one table element and at least one non-table element.

15. A computing system for generating a diagram representing dependencies between elements of an enterprise resource planning software package, the computing system comprising:
a component that receives a selection of modules, each module having a number of associated table and non-table elements;
a component that identifies a first set of dependent relationships between the elements of the selected modules; and
a component that renders the elements associated with the selected modules and the identified first set of dependent relationships in an interactive diagram
so that the table and non-table elements are visually represented in the diagram simultaneously.

16. The computing system of claim 15, further comprising:
a component that receives a selection of a rendered element;
a component that identifies a second set of dependent relationships between the selected element and elements that are external to the selected modules;
a component that receives a selection of at least one dependent relationship from the identified second set of dependent relationships; and
a component that displays an indication of the selected at least one dependent relationship from the identified second set of dependent relationships.

17. The computing system of claim 16 wherein the selected at least one dependent relationship is an incoming dependency relative to the selected element.

18. The computing system of claim 16 wherein the selected at least one dependent relationship is an outgoing dependency relative to the selected element.

19. The computing system of claim 16, further comprising:
a component that receives a selection of an element; and
a component that displays an indication of dependency modules of the selected element.

20. The computing system of claim 19 wherein each dependency is categorized as either declarative or imperative.
